(19) United States
(12) Patent Application Publication
(10) Pub. No.: US 2018/0336593 A1
(43) Pub. Date: Nov. 22, 2018

(54) CONTROL METHOD FOR INFORMATION PRESENTATION AND PUBLIC MOBILE DEVICE

(71) Applicant: CHIGOO (SHANGHAI) INTERACTIVE TECHNOLOGY CO., LTD., Shanghai (CN)

(72) Inventors: Tao Chen, Shanghai (CN); Ming Lei, Shanghai (CN)

(21) Appl. No.: 15/702,088

(22) Filed: Sep. 12, 2017

Related U.S. Application Data
(63) Continuation of application No. PCT/CN2017/089206, filed on Jun. 20, 2017.

(30) Foreign Application Priority Data
May 16, 2017 (CN) 201710346912.8

(51) Int. Cl. G06Q 30/02

(52) U.S. Cl. CPC G06Q 30/0261; G06Q 30/0267

(57) ABSTRACT

Disclosed is a control method for information resource presentation of a public mobile device, comprising: the public mobile device determining a region type of a location that it locates during movement; the public mobile device determining an information resource presentation rule matching the region type according to the determined region type, wherein different region types correspond to different information resource presentation rules; and the public mobile device presenting an acquired information resource according to the determined information resource presentation rule. The presentation of information resources may cover as many audiences as possible by means of the movement of the public mobile device. In addition, by means of employing different presentation rules at different types of locations, the presentation control of the information resources is more flexible, satisfying the information resource presentation requirements of an information resource provider and improving user experience and presentation effects.

### CROSS REFERENCE TO RELATED APPLICATIONS

This application is a continuation of International Application No. PCT/CN2017/089206, filed on Jun. 20, 2017, which is based upon and claims priority to Chinese Patent Application No. 201710346912.8, filed on May 16, 2017, the entire contents of each of which are incorporated herein by reference.

### TECHNICAL FIELD

The embodiments of the present invention relate to the technical field of information distribution and, in particular, to controlling information resource presentation of a public mobile device.

### BACKGROUND

With development of information technologies, many information presentation forms such as advertisements are more popular. Effective presentation of information resources may propagate information to users, thus realizing the purpose of information promotion. To realize effective information propaganda and promotion, information resources are usually delivered in various public places where people gather, such as airports, stations, and so on.

However, as the value of advertisements is high in public places where people gather, advertisement space becomes rare, and thus expensive. For example, large electronic display screens may be installed at the security checkpoints in some airports where many passengers pass by, and issue advertisement information that can cover departing passengers of the airport. The number of advertisements during one circulating playing is typically limited (generally 20-30), and thus the price for issuing advertisements at security checkpoints is very expensive. Most advertisers may thus choose other advertising positions (such as a boarding gate) covering some passengers given their limited competitive capabilities (e.g., financial capabilities).

In addition, in existing airports, information is usually presented on fixed large electronic display screens. Although these large electronic display screens have some information propagation capabilities, the effects are limited since their locations are fixed. Only a limited number of devices can be provided at a single boarding gate given the large size of the devices and public service specifications. Furthermore, devices at fixed locations may be easily blocked by people, and thus cannot effectively service a large amount of passengers.

Also, existing information resources are usually presented with uniform presentation rules at different areas of the same site where they are delivered. However, the different requirements for different deliveries at different areas, and by different information resource providers, is neglected, and it is therefore difficult to effectively control the presentation of information resources.

In reality, there are still some situations where some information resources are presented randomly or in a fixed circulating order. Although such a presentation method can realize the purpose of information promotion, severe resource waste may occur, as information presentation consumes hardware resources associated with the playing devices. Furthermore, such presentation methods may consume network resources and cause great financial burdens to the information resource provider, as the number of times information resources are presented is not limited when being presented in a circulating random or fixed order. Thus, the information resource provider's financial burden is further increased, while good information presentation effects are not realized.

In practice, such situation may occur in which some information contents (such as advertisements) may be displayed continuously before other information contents appear. As such, a user may repeatedly see certain information content within a very short time period, which not only deteriorate user experience but also harms the interest of the advertisement information providers.

In view of the above, the existing information resource presentation technologies commonly have problems related to requirements of the information providers (such as advertisers) on effective information issuance (covering more audiences) and relief of financial burden cannot be well satisfied. Moreover, the existing information resource presentation technologies provide a poor user experience, the control of information resource presentation is not flexible, resources are wasted, and the presentation effects are poor.

### SUMMARY

A control method for information resource presentation of a public mobile device is provided according to an embodiment of the present invention to solve the aforementioned problems in the prior art.

As used herein, the term “information resources” may refer to any suitable type of data or information that is displayed, delivered, transmitted, or otherwise presented to a user. Thus, the term “information resource” or “information resources” may be considered synonymous with terms such as “data” or “information.”

Embodiments also include a public mobile device, which may be a public service facility provided for the public, such as a trolley in an airport. In embodiments, the public mobile device may be applied to various large public places where people gather, such as airports, stations, wharfs, shopping malls, and so on.

According to a first aspect of the present invention, a control method for information resource presentation of a public mobile device is provided according to an embodiment of the present invention, comprising: determining a region type of the public mobile device's location during the public mobile device's movement; determining, by the public mobile device, an information resource presentation rule matching the region type according to the determined region type, wherein different region types correspond to different information resource presentation rules; and presenting, by the public mobile device, an acquired information resource according to the determined information resource presentation rule.

In an embodiment, the public mobile device may determine an information resource presentation rule matching the determined region type. For instance, when the determined region type of the location is a general region type, a general information resource presentation rule may be selected matching the general region type, wherein the general information resource presentation rule depends on the number of times information content is issued. Moreover, when the determined region type of the location is a designated region type, a designated information resource presentation rule may be selected matching the designated region type, wherein the designated information resource presentation rule depends on the number of times information content is issued and an information resource preference of a user.

The designated region type generally refers to regions in a public place where people are apt to gather, and thus can facilitate presenting information resources to the gathering people. The general region type generally refers to locations except the designated regions. For example, in an airport, a designated region may be a boarding gate of the airport, and the general region may be a passage of the airport.

Preferably, the information resource preference of the user may comprise an object of interest to the user. The object may include, for example, a destination.

Furthermore, the designated information resource presentation rule may be generated according to the following steps: determining, according to various objects of interest to the user, various information content sets associated with the various objects in an information content pool including un-presented information contents in information resources provided by an information resource provider; determining a sequential order of information contents to be issued to generate an information content sequence according to firstly, the quantity priority of information contents in the various information content sets, secondly, the interest priorities of the various objects, and finally, the priorities of the issuing sequence numbers of various information contents in the information content sets; and using the generated information content sequence as an information resource to be presented.

Furthermore, the designated information resource presentation rule may be generated according to the following steps: determining, according to various objects of interest to the user, various information content sets associated with the various objects in an information content pool consisting of un-presented information contents in information resources provided by an information resource provider; determining a sequential order of information contents to be issued to generate an information content sequence according to, firstly, the quantity priority of information contents in the information content sets, secondly, the interest priorities of the various objects, thirdly, the priority of the number of times of issuing various information contents required by the information resource provided in the information content sets, and finally, the priorities of the issuing sequence numbers of various information contents in the information content sets; and using the generated information content sequence as an information resource to be presented.

Preferably, the information resource preference of the user may comprise: an upper limit and a lower limit of the playing frequency of an information content preferred by the user.

Furthermore, the designated information resource presentation rule may be generated according to the following steps: setting multiple types of playing frequencies corresponding to various information contents according to the number of times various information contents are issued from various information content providers, and the upper limit and the lower limit of the playing frequency of the information content preferred by the user, wherein the number of types of the playing frequencies is smaller than the number of types of issues; and generating an information content sequence to be used as an information resource to be presented according to the set multiple types of playing frequencies corresponding to the various information contents.

According to a second aspect of the present invention, a non-volatile computer storage medium storing a computer-executable program is provided according to an embodiment of the present invention, and the computer-executable program may be used to implement the control method for information resource presentation of a public mobile device mentioned above.

According to a third aspect of the present invention, a public mobile device is provided according to an embodiment of the present invention, comprising: at least one processor, a wireless communication device capable of communicating with a server, at least one display, and a memory. The memory may store a program executable by the at least one processor, and the program may be executed by the at least one processor such that the at least one processor implements the control method for information resource presentation of a public mobile device mentioned above.

Compared to the related art, the technical solution provided in the present invention at least has the following advantages:

Restriction by site can be avoided through movement of the public mobile device. For example, a trolley in an airport may move to different locations in the airport such as security checkpoint, boarding gates, and so on. In addition, by means of the public service function of the public mobile device, the public mobile device can naturally move with the flow of people within a movement region (such as an isolated region of the airport). In a designated region where people gather (such as boarding gate for flight), presenting information resources on the public mobile device can cover most of the population at that location (such as departing passengers in the airport), satisfying the appeal of an information resource provider with an information resource presentation covering as many audiences as possible.

The present invention employs different presentation rules to present information resources according to different location types of the public mobile device, such that the control of information resource presentation is more flexible, thus realizing targeted presentation of information resources and satisfying various information resource presentation requirements of various information resource providers. In addition, presenting information resources with different presentation rules at different locations improves the effect of the information resources being received by the user by means of a change in presentation rules, thus improving user experience and the effect of information resource presentation.

By designating information resource presentation rules according to priorities, the present invention not only takes an object of interest to the user into account, but also takes the requirements of the information resource providers into account, realizing multiple dimensions of priority control, spreading the presentation of information contents, effectively controlling the number of times of information resources presentation, avoiding resource waste, and improving the user experience, thereby further improving the effect of information resource presentation.

The embodiments described herein reduce the financial burden of the information resource providers for covering as many audiences as possible by means of designating information resource presentation rules with differential frequencies on the basis of satisfying the requirements of the information resource providers to cover as many audiences as possible. In addition, effective differential playing frequency control enables the user to be impressed by information contents more easily, producing better information presentation effects.

### BRIEF DESCRIPTION OF THE DRAWINGS

To facilitate clear illustration of the technical solutions in the embodiments of the present invention or in the prior art, the accompanying drawings to be used in the description of embodiments or the prior art will be introduced hereinafter briefly.

FIG. 1 is a flowchart of a control method for information resource presentation of a public mobile device, according to an embodiment of the present invention;

FIG. 2 is a flowchart of the generation of a designated information resource presentation rule, according to an embodiment of the present invention;

FIG. 3 is a flowchart of the generation of another designated information resource presentation rule, according to an embodiment of the present invention;

FIG. 4 is a flowchart of the generation of yet another designated information resource presentation rule, according to an embodiment of the present invention;

FIG. 5 is a flowchart of the generation of the information content sequence shown in FIG. 4, according to an embodiment of the present invention; and

FIG. 6 is a diagram showing the structure of a public mobile device, according to an embodiment of the present invention.

### DETAILED DESCRIPTION

In order to make the object, technical solution, and advantages of the embodiments of the present invention more clear, hereinafter, the technical solution in the embodiments of the present invention will be described clearly and completely in combination with the drawings in the embodiments of the present invention. Obviously, the described embodiments are some embodiments of the present invention rather than all embodiments. The embodiments described herein are done so by way of example, and additional or alternative embodiments may fall within the scope of the present invention based on the teachings of the present disclosure.

The embodiments of the present invention can be applied to various large public places where people gather, such as airports, stations, wharfs, shopping malls, and so on.

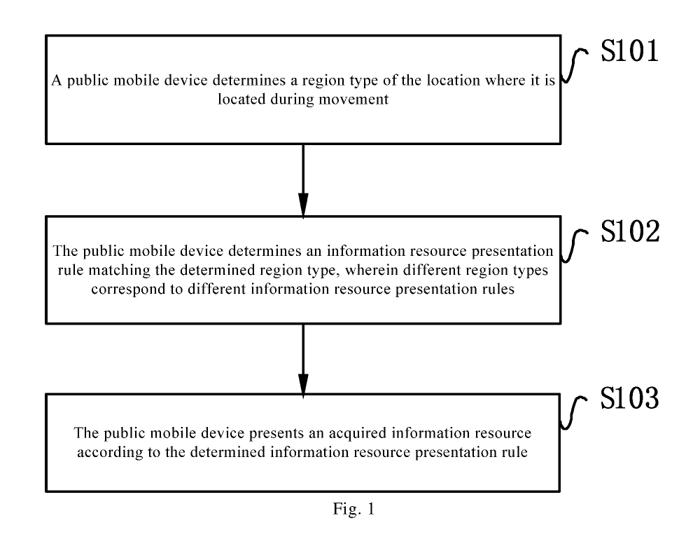

FIG. 1 is a flowchart of a control method for information resource presentation of a public mobile device according to an embodiment of the present invention. As shown in FIG. 1, the method may include the following steps.

In step 101, the public mobile device determines, during its movement, a region type associated with a location where it is located.

In this embodiment, the public mobile device may be a public service facility provided for the public, such as a trolley in an airport. The public mobile device may be deployed or even movable in various regions, such as an airport, a city, a country, or around the world. The region type may include a designated region type and a general region type. For instance, when the public mobile device is a trolley in an airport, the designated region type may be a boarding gate region, whereas the general region type may be an airport passage region. The public mobile device may determine the region type of the location where it is located in various ways.

In an alternative embodiment, the public mobile device may determine the region type associated with a location where it is located during movement in step S101 by determining, according to a pre-stored complete map of a movement region range and the current location coordinates thereof in the movement region, the location of the public mobile device on the complete map; and the public mobile device may determine the region type of the location where it is located according to the types of various location regions that have been divided and/or assigned in advance on the complete map.

To provide an illustrative example, the public mobile device may be a trolley and the movement region may be an airport. In such a case, the region types may be divided in advance within a complete map of the airport. The trolley may acquire the location coordinates thereof by means of any suitable type of positioning technology to determine the location thereof on the complete map, and then determine the region type corresponding to that location. The complete map data of the airport may be pre-stored, for example, in a local storage space of the trolley or obtained via a third party service interface. The positioning technology may be any suitable type and/or number of indoor and outdoor positioning technologies (or combinations thereof).

As such, the public mobile device may obtain a complete map of a movement region range to rapidly and accurately determine the region type of the location where it is located.

In another alternative embodiment, the public mobile device may determine the region type of the location where it is located during movement in step S101 such that, when the public mobile device determines that it is nearby a pre-stored known location reference point of a designated region type, the public mobile device determines that the region type associated with that location is a designated region type.

In accordance with such embodiments, a plurality of locations with known designated region types may be preset in the movement region of the public mobile device. To provide an illustrative example, when the movement region is an airport, the airport may be divided as a boarding gate region and an airport passage region. The boarding gate region may be of a designated region type, and the airport passage region may be of a general region type. When the public mobile device is nearby a certain known boarding gate, the public mobile device determines the region type of the place where it is located as the boarding gate location. Otherwise, if the public mobile device is not nearby any known boarding gates, the public mobile device determines the region type of the location where it is located as the airport passage location.

As such, the public mobile device may obtain a plurality of known locations of designated region type preset in the movement region, which ensures that the region type of the location where the public mobile device is located can be determined effectively while reducing capital investment.

In yet another alternative embodiment of the present invention, the public mobile device determines the region type of the location where it is located during movement in step S101 such that, when the public mobile device determines that it is nearby a plurality of other in-use public mobile devices exceeding a preset number, the public mobile device determines that the region type of the location where it is located is a designated region type.

In accordance with such embodiments, this preset number may be a configurable parameter, the size of which being adjusted according to the actual need (e.g., 20). For example, the public mobile device may be equipped with a Bluetooth or infrared module, or other suitable sensing devices. The selection of the sensing device may take the sensing or detection distance thereof into account, and this distance may be selected according to the set size of a region. For example, if a Bluetooth or infrared function is started, other public mobile devices of same type in the rated detection distance region thereof may be detected and counted, thereby determining the number of other public mobile devices in the same range. When the counting reaches a preset number, the region type of the location where it is located is determined as a designated region type. “In use” herein excludes the situation where the public mobile devices are powered off, in a sleep state, or otherwise not in use (e.g., located at a recycling place). To provide an illustrative example, is the public mobile device is a trolley in an airport, if some in-use trolleys greater than or equal to a preset number (such as 20) gather together, it indicates that a certain number of users have also gathered together since “trolleys move with people flow and gather as people gather,” thereby determining that the trolley is at the boarding gate region. Otherwise, the trolley determines that it is located at the airport passage region.

As such, even if there is no cooperation with operators in a public place (such as airport operators), the public mobile device may still determine the region type associated with its location according to the mutual location relationship with other in-use public mobile devices. In doing so, capital investment may be saved, and at the same time the determination of the region type of the location of the public mobile device may be realized.

In still another alternative embodiment of the present invention, the public mobile device may determine the region type associated with its location during movement in step S101 such that, when the public mobile device determines that it is nearby a plurality of other in-use public mobile devices exceeding a preset number, and the public mobile device and at least some of the plurality of other in-use public mobile devices (e.g., most of the other in-use public mobile devices, which may include a number in excess of some proportion or threshold, such as two-thirds, for example) are substantially in a static state, the public mobile device may determines that the region type associated with its location is a designated region type.

In accordance with such embodiments, the static state may represents that the movement speed of the public mobile device is very small, or the public mobile device is otherwise static. In various embodiments, the movement speed of the public mobile device may be considered as static when it does not exceed any suitable threshold velocity within any suitable period of time. For instance, the public mobile device may be considered as static when moving less than 4 km/h, and the continuous movement time does not exceed 3 minutes.

As such, in the case of saving capital investment, special situations where public mobile devices are transported together are further excluded. At the same time, the resource waste is reduced, the accuracy of determining a region type associated with the location of the public mobile device is improved, which is more beneficial for the realization of better information resource presentation effects.

In still another alternative embodiment, the public mobile device may determine a region type associated with its location during movement in step S101 such that, when the public mobile device determines that the region type associated with its location is not a designated region type, the public mobile device determines that the region type is a general region type other than the designated region type.

As such, with the current processing power, no additional determination of region type is needed, and no additional capital and device investment is needed, thereby reducing data processing volume and realizing rapid and accurate determination of the region type.

In step 102, the public mobile device may determine an information resource presentation rule matching the region type according to the determined region type, wherein different region types correspond to different information resource presentation rules.

In step 103, the public mobile device may present the acquired information resource according to the determined information resource presentation rule.

To provide an illustrative example, if the public place is an airport, the public mobile device is a trolley in the airport, and the information resource is an advertisement, the acquisition of the information resource (i.e., the acquisition of the advertisement) may be determined according to the boarding gate where the trolley is located. That is, an advertisement related to the destination is acquired according to each of the flight destinations departing from the boarding gate where the trolley is currently locatedy. In particular, when the trolley moves within range of the boarding gate (e.g., within a threshold range), it is determined that the trolley is located at the boarding gate region, and an advertisement related to the destination may be displayed at the boarding gate. That is, an advertisement matching the destination may be played according to the flight destination information of the boarding gate where the trolley is currently located. When the trolley is not within range of any boarding gate, then it may be determined that the trolley is located at an airport passage region, and a passage advertisement will be played. Even if the trolley is not in the flight waiting area or is not located in the airport (but is located somewhere else), the passage advertisement may also be played. As used herein, a passage advertisement refers to an advertisement that is not associated with the destination, such as a brand advertisement suitable for a prefecture, a country, or the world (e.g., Coca Cola), etc.

According to the control method for information resource presentation as discussed above, limitation by site may be avoided by means of the movement of the public mobile device. For example, a trolley in an airport may move to different locations in the airport such as security checkpoints, boarding gates, and so on. In addition, by means of the public service function of the public mobile device, the public mobile device may naturally move with the flow of people in a movement region thereof (e.g., an isolated region of the airport). In a designated region where people gather (such as boarding gate for flight), presenting information resources on the public mobile device may cover most of the population at that particular location (such as departing passengers in the airport), satisfying the appeal of an information resource provider that information resource presentation covers as many audiences as possible.

In embodiments, different presentation rules may be employed to present information resources according to different location types of the public mobile device, such that the control of information resource presentation is more flexible. In this way, targeted presentation of information resources is realized while satisfying various information resource presentation requirements of various information resource providers. In addition, presenting information resources with different presentation rules at different locations improves the effect of the information resources being received by the user by means of the change in presentation rules, thus improving user experience and the effect of information resource presentation.

In an alternative embodiment of the present invention, the public mobile device may determine an information resource presentation rule matching the region type according to the determined region type in step 102 such that, when the determined region type of the location is a general region type, a general information resource presentation rule matching the general region type may be selected, wherein the general information resource presentation rule depends on the number of times an information content is issued. Moreover, when the determined region type of the location is a designated region type, a designated information resource presentation rule matching the designated region type may be selected, wherein the designated information resource presentation rule depends on the number of times an information content is issued and an information resource preference of a user.

The information resource preference of the user may include, for instance, an upper limit and a lower limit of the playing frequency (i.e., the number of times an information content is played within a unit time) of an information content preferred by the user.

As used herein, the number of times an information content is issued may be the number of times the information content is presented within an issuing time period designated by an information resource provider. An information resource provider (such as an advertiser) may generally control the number of issues of one information content for the sake of making the same information content (such as advertisement) reach more users with a fixed budget. That is, an information resource provider may control the number of times the information content is viewed by the user within a designated time. The information resource preference of the user refers to the degree the user accepts the information resource, which comprises an upper limit and a lower limit of the playing frequency of an information content preferred by the user. The object of information presentation is to make people impressed. Thus, if the number of times an information resource is played is too small within a designated time period (i.e., the playing frequency value is too low), then no deep impression will be produced and information presentation cannot be impressive to users. If the number of times an information resource is played is too big within a designated time period (i.e., the playing frequency value is too high), then users will suffer from visual fatigue, causing unnecessary resource waste. In embodiments, the upper limit and the lower limits of the playing frequency value may be any suitable number to effectuate the desired result. For example, the upper limit of the playing frequency value may be once per 2 minutes, and the lower limit of the playing frequency value may be once per 25 minutes.

The present invention sets different presentation rules according to different location types of the public mobile device, realizing differential playing control and spreading the presentation of information content, effectively controlling the number of times an information resource is presented to avoid resource waste and lower financial burden. In addition, an effective differential playing control enables the user to be impressed by information contents more easily, producing better information presentation effects.

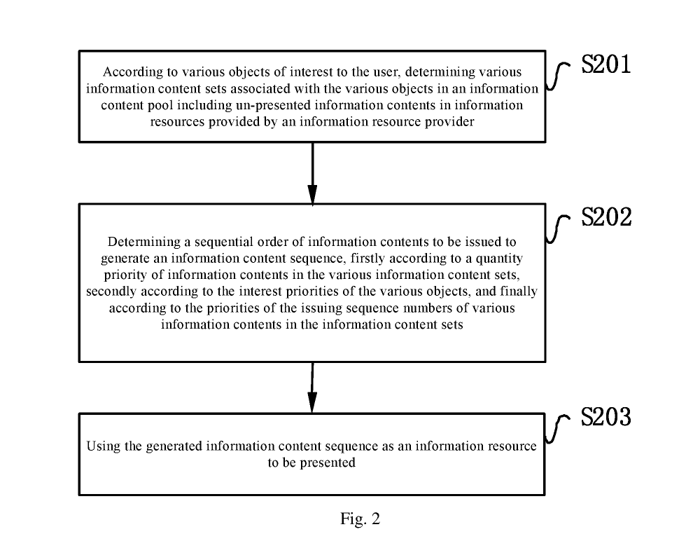

FIG. 2 is a flowchart of the generation of a designated information resource presentation rule according to an embodiment, wherein the information resource preference of a user includes an object of interest to the user. The object may include, for example, a destination. The user may be, for example, the current user of the public mobile device. In an embodiment, referring to FIG. 2, the generation steps may be as follows: in S201, according to various objects of interest to the user, determining various information content sets associated with the various objects in an information content pool including un-presented information contents in information resources provided by an information resource provider. Step S202 may include determining the sequential order of information contents to be issued to generate an information content sequence, firstly according to the quantity priority of information contents in the various information content sets, secondly according to the interest priorities of the various objects, and finally according to the priorities of the issuing sequence numbers of various information contents in the information content sets. Step S203 may include using the generated information content sequence as an information resource to be presented.

The quantity priority of information contents in various information content sets refers to the information content set that contains more information contents is preferential. The interest priorities of the various objects refers to an information content that contains a designated object is preferential to one that has no designated object. The priority of the issuing sequence number refers to an information content that has a small issuing sequence number being preferential. These various priorities may be adjusted according to the needs. For example, the quantity priority of information contents in the various information content sets may be that an information content set which contains less information contents is preferential. The interest priorities of various objects may be that an information content having no designated object is preferential. The priority of the issuing sequence number refers to an information content that has a larger issuing sequence number is preferential. After the presentation rule is adjusted, the public mobile device may then automatically present information resources according to new presentation rules.

Taking an airport as an example, the object may be a destination that corresponds to the issuing destination of an information content. The quantity priority may be that information contents associated with the same destination that are larger in number are preferential. The interest priority of the object may be that an information content having a designated issuing destination is preferential than one having no designated issuing destination (i.e., the issuing destination is ALL). The priority of the issuing sequence number may be that an information content having a smaller issuing sequence number is preferential.

By designating a priority rule for an information resource presentation and taking into account the object of interest to the user, multiple dimensions of priority control may be realized, spreading of the presentation of information contents, the user experience, and the effect of information resource presentation can all be improved.

In an alternative embodiment, the above information content sequence may be generated according to the following steps. Step 1 may include determining various information content sets associated with the various objects in the information content pool. Step 2 may include determining the number of information contents in the various information content sets. Step 3 may include selecting at least one information content set with the largest number of information contents. Step 4 may include selecting an information content set with the highest interest priority from the at least one information content set according to the preset interest priorities of the various objects. Step 5 may include selecting an information content with the smallest sequence number from an information content set with the highest interest priority in the information content pool, and adding the information content with the smallest sequence number to the head (i.e., lead, or first) position of a blank region of an information content sequence to be presented. Additionally, steps 1 to 5 may be circulated, or repeated, until the blank region is fully filled.

To provide an illustrative example to describe the implementation of the above rule, an advertisement may be presented by a trolley in an airport. In such a case, the public mobile device may be a trolley, the public place may be an airport, the designated region may be an airport boarding gate, the general region may be an airport passage, and the information resource may be an advertisement. The advertisement may be obtained by matching the destination of a flight departing from the boarding gate where the public mobile device is located. That is, an advertisement having an advertisement issuing destination that is the same as the flight destination is acquired. Moreover, the object may be the issuing destination of the advertisement. The information content pool is then filled with each of the advertisements to be presented.

Continuing this example, it is assumed that the trolley is at boarding gate A100, and the advertisement information obtained by means of matching at a time 14:00. If there are 3 advertisements with all issuing destinations, there are 3 advertisements with ‘A’ issuing destinations, and there are 2 advertisements with ‘B’ issuing destinations.

| Issuing sequence number | Advertisement ID | Issuing destination |
|---|---|---|
| 1 | T1 | ALL |
| 2 | T2 | ALL |
| 3 | T3 | ALL |
| 4 | A1 | A |
| 5 | A2 | A |
| 6 | A3 | A |
| 7 | B1 | B |
| 8 | B2 | B |

In an embodiment, the information resource presentation rule shown in FIG. 2 may be executed as follows. P1-quantity preferential: under the same destination, an information resource with more advertisement is preferential, and those advertisements which are already added into a sequence are subtracted from the total count. P2-issuing destination preferential: an information resource with a designated issuing destination is preferential than that having ALL issuing destinations. P3-issuing sequence number preferential: an information resource with smaller issuing sequence number is preferential; there is only one advertisement issuing destination. The principle of determining the issuing destination is thus as follows. For example, the issuing destination of advertisement A1 is Shanghai and Jiangsu. When it is necessary to retrieve advertisements according to Nanjing, A1 will be sorted out. When it is necessary to retrieve advertisements according to Nanjing and Shanghai, A1 may be identified, or selected, twice. Thus, the higher-ranked destination prevails; that is, the second destination is omitted. The circulating sequence of the above 8 advertisements according to the above sequence priority rule may then be: A1-T1-A2-B1-T2-A3-B2-T3, which will be sequentially played circularly.

In another embodiment, during the circulating playing of the information content sequence, when a playing control instruction on reducing the playing frequency of at least one information content is received, the at least one information content is removed from the information content sequence to generate a shortened information content sequence, with each playing control instruction containing a respective intercut period.

During the circulating playing of the shortened information content sequence, the at least one information content that was removed is inserted according to its intercut period. Here, the intercut period is the shortened information content sequence being subjected to one intercut when being played for the i-th time, with i being a constant value or a random variable.

Moreover, when the information content has timed out or other situation occurs (for example, the information content provider actively requires to reduce the number of times an information content is presented), there is no need to play the information content frequently. In such a scenario, the server may regularly monitor the presentation requirement change of these information contents, and directly modify the current information content sequence. This may be done, for example, by directly removing all information contents that are required to reduce the number of presentations from the current information content sequence and conduct intercut in the shortened content sequence according to the intercut period of the respective contents that are removed. As such, the data processing volume for re-determining the sequence is reduced, and the presentation requirement of the information content is satisfied.

Continuing the previous example using the boarding gate A100 and the advertisement information obtained by means of matching at 14:00, after the intercut period is introduced, the advertisement configuration is assumed to be as follows:

| Issuing | Advertisement | Intercut | Issuing |
|---|---|---|---|
| sequence number | ID | period number | destination |
| 1 | T1 | 1 | ALL |
| 2 | T2 | 1 | ALL |
| 3 | T3 | 1 | ALL |
| 4 | A1 | 1 | A |
| 5 | A2 | 1 | A |
| 6 | A3 | 2 | A |
| 7 | B1 | 3 | B |
| 8 | B2 | 1 | B |

The advertisement intercut period number refers to the advertisement circulating sequence period number between the two playing of the advertisement.

a) At this moment, the advertisement circulating sequence is determined as follows according to the basic priority rule: A1-T1-A2-B1-T2-A3-B2-T3.

b) An advertisement intercut period number which is greater than 1 is removed from the circulating sequence to obtain the final circulating sequence A1-T1-A2-T2-B2-T3.

c) The intercut period number of advertisement A3 is 2, that is, A3 is inserted (intercut) once when the above circulating sequence A1-T1-A2-T2-B2-T3 is played twice.

d) The intercut period number of advertisement B1 is 3, that is, B1 is inserted (intercut) once when the above circulating sequence A1-T1-A2-T2-B2-T3 is played three times.

e) Thus, the advertisement circulation is:

A1-T1-A2-T2-B2-T3-A1-T1-A2-T2-B2-T3-A3-A1-T1-A2-T2-B2-T3-B1-A1-T1-A2-T2-B2-T3-A3.

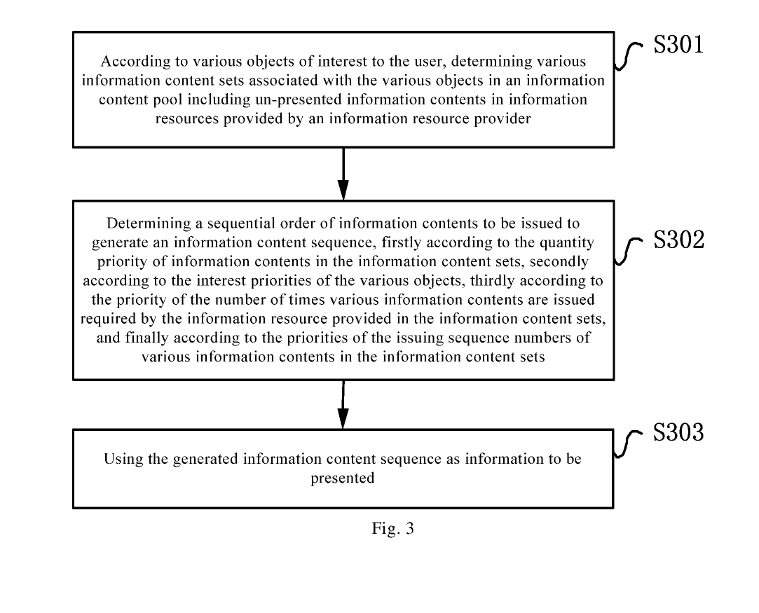

FIG. 3 is a flowchart of the generation of yet another designated information resource presentation rule provided according to an embodiment.

Referring to FIG. 3, the generation steps may be as follows. Step S301 may include, according to various objects of interest to the user, determining various information content sets associated with the various objects in an information content pool including un-presented information contents in information resources provided by an information resource provider. Step S302 may include determining the sequential order of information contents to be issued to generate an information content sequence, firstly according to the quantity priority of information contents in the information content sets, secondly according to the interest priorities of the various objects, thirdly according to the priority of the number of times various information contents are issued as required by the information resource provider in the information content sets, and finally according to the priorities of the issuing sequence numbers of various information contents in the information content sets. Step S303 may include using the generated information content sequence as an information resource to be presented.

The description and adjustment rules of the number priority of the information contents in the information content sets, the interest priorities of various objects, and the sequence number priorities of various information contents are the same as those of the various priorities in FIG. 2. Therefore, these will not be further described herein for purposes of brevity. The priority of issuance times refers to an information content that has more issuance times being preferential.

Embodiments also including adjusting respective priorities. Taking the priority of issuance times as an example, the information content having less issuance times may be preferential. After the presentation rule is adjusted, the public mobile device may automatically present information resources according to the new presentation rules.

In an alternative embodiment, the above information content sequence may be generated according to the following steps. Step 1 may include determining various information content sets associated with the various objects in the information content pool. Step 2 may include determining the number of information contents in the various information content sets. Step 3 may include selecting at least one information content set with the largest number of information contents. Step 4 may include selecting a first information content set with the highest interest priority from the at least one information content set according to the set interest priorities of the various objects. Step 5 may include selecting a second information content set with the largest number of times an information content is played from the first information content set. Step 6 may include selecting an information content with the smallest sequence number from the second information content set in the information content pool, and adding an information content with the smallest sequence number from the second information content set to the head (i.e., lead) position of a blank region of an information content sequence to be presented. Steps 1 to 6 may then be circulated or repeated until the blank region is fully filled.

Based on the above presentation rules, both the needs of the user and that of the information resource provider are taken into account, thus realizing multiple dimensions of priority control, effectively controlling the number of information resources that are presented without affecting user experience, and realizing more targeted presentation of information resources.

Continuing the previous example for the boarding gate A100 and the advertisement information obtained at 14:00, after the advertisement playing number is introduced, the advertisement configuration is assumed to be as follows:

| Issuing | Advertisement | Advertisement | Issuing |
|---|---|---|---|
| sequence number | ID | playing number | destination |
| 1 | T1 | 2 | ALL |
| 2 | T2 | 2 | ALL |
| 3 | T3 | 2 | ALL |
| 4 | A1 | 1 | A |
| 5 | A2 | 1 | A |
| 6 | A3 | 2 | A |
| 7 | B1 | 3 | B |
| 8 | B2 | 1 | B |

The advertisement playing number refers to the number of times an advertisement is played within one circulating playing period.

At this moment, the circulation sequence priority rule set according to the steps shown in FIG. 3 is as follows. P1-quantity preferential: under the same destination, an information resource with more advertisements is preferential. When an advertisement is presented once, the weight is decremented by 1, and when the weight gets to 0, the quantity is decremented by 1. P2-issuing destination preferential: an information resource with a designated issuing destination is more preferential than one having an ALL issuing destination. P3-advertisement playing number preferential: the playing of an advertisement with a higher advertisement playing number is preferential. P3-issuing sequence number preferential: an information resource with a smaller issuing sequence number is preferential.

Thus, the circulating sequence of the above 8 advertisements according to the above sequence priority rule is: A3-A1-T1-T2-T3-T1-B1-B1-A2-B1-T2-A3-B2-T3, and will be sequentially played circularly.

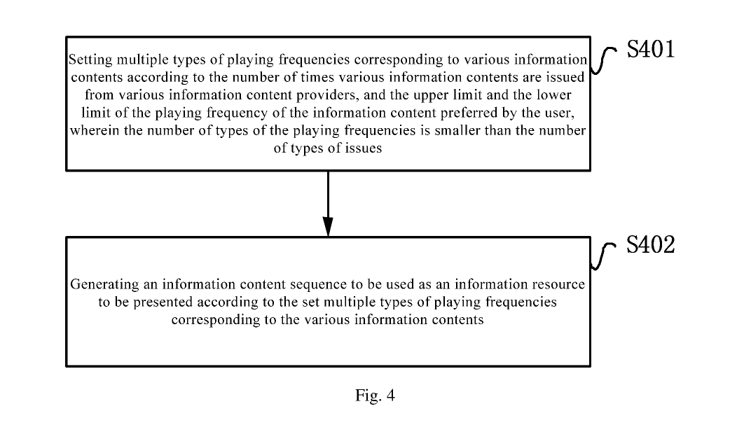

FIG. 4 is a flowchart of the generation of yet another designated information resource presentation rule, according to an embodiment. Referring to FIG. 4, the generation steps of the designated information resource presentation rule are as follows.

In step S401, multiple types of playing frequencies corresponding to various information contents may be set according to (i) the number of times various information contents are issued from various information content providers, and (ii) the upper limit and the lower limit of the playing frequency of the information content preferred by the user, with the number of types of the playing frequencies being smaller than the number of types of issues.

In accordance with such embodiments, on the basis of satisfying the requirements of the information resource provider to the number of times an information content is issued, the playing frequencies of various information contents may be rationally set between the upper limit value and the lower limit value of the playing frequency of the information content preferred by the user.

In an alternative embodiment, there may be any suitable number of playing frequencies having an integral multiple relationship (or any other suitable proportionality) between one another. For example, there may be at least two playing frequencies, and among these two playing frequencies, the higher playing frequency may be an integral multiple of the lower playing frequency. To provide an illustrative example, the information content may include two playing frequencies of once/2 min and once/4 min, respectively. To provide another illustrative example, the information content may also include three playing frequencies, such as once/2 min, once/4 min, and once/8 min.

Such a constraint on the relationship among the various playing frequencies may facilitate computation such that the generation of the information content sequence is easier to realize.

In step S402, an information content sequence may be generated to be used as an information resource to be presented according to the set multiple types of playing frequencies corresponding to the various information contents.

According to the rule of presenting the designated information resource using frequencies differentiation as mentioned above, the requirement of information resource providers to cover as many audiences as possible may be satisfied, while the financial burden thereof may be reduced by means the frequencies differentiation. In addition, effective control of the playing frequency differentiation enables the user to be impressed by information contents more easily, producing better information presentation effects.

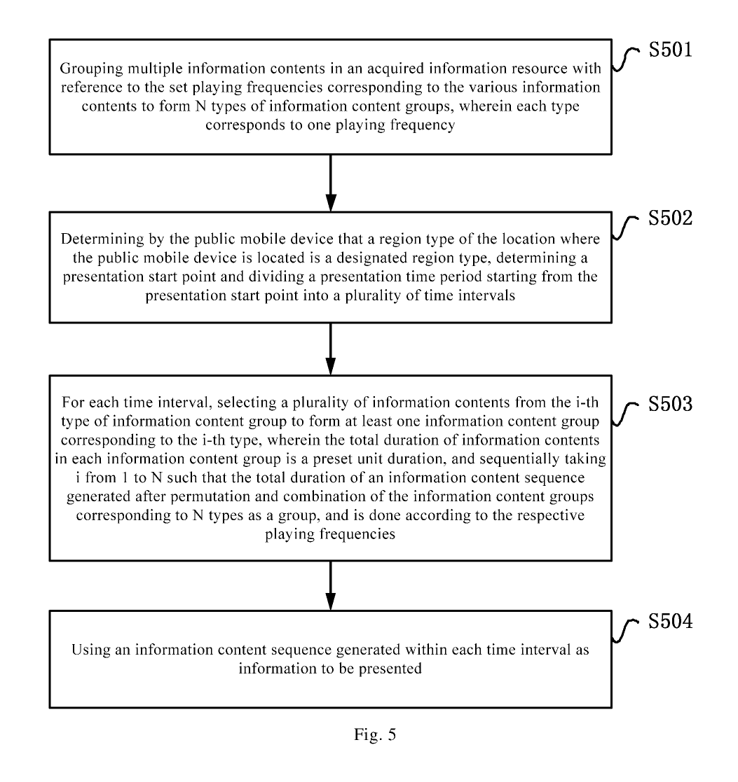

In an alternative embodiment, referring to FIG. 5, the process of generating an information content sequence to be used as an information resource to be presented according to the set multiple types of playing frequencies corresponding to the various information contents may comprise the followings steps.

In step S501, multiple information contents in the acquired information resource may be grouped with reference to the set playing frequencies corresponding to the various information contents, to form N of information content groups, with each type corresponds to one playing frequency.

In accordance with such embodiments, the information resource acquired by the public mobile device may include, for example, k (k>1) pieces of information contents which are represented by A, with A={A₁, A₂, . . . , Aₖ}

Furthermore, there are N playing frequencies in an information content, which are represented by F={F₁, F₂, . . . , F_{N}}, where the playing frequencies in the set F are arranged from high to low, i.e., F₁>F₂> . . . >F_{N}.

As such, N types of groups: G={G₁, G₂, . . . , Gᵢ, G_{N}} corresponding to N playing frequencies are formed one by one after grouping according to various playing frequencies. to provide an illustrative example, an information content may have three playing frequencies F={F₁, F₂, F₃}, with three groups corresponding to various playing frequencies in playing frequency F being obtained by grouping according to the playing frequency, which are represented as G₁, G₂, G₃, respectively. Thus, each of the so grouped G₁, G₂, G₃ may include an information content with playing frequency F₁, an information content with playing frequency F2, and an information content with playing frequency F₃.

In step S502, when the public mobile device determines that the region type of the location where it is located is the designated region type, a presentation start point may be determined, and a presentation time period starting from the presentation start point may be divided into a plurality of time intervals.

In accordance with such an embodiment, the preset duration may be a configurable parameter, and may be adjusted according to the actual need. For example, the preset duration may be set as 50 minutes. In embodiments, the preset duration may generally be set according to a time length in which the public mobile device stops and gathers in a designated region (e.g., for some threshold duration of time). To provide an illustrative example, the public mobile device may be a trolley, the public place may be an airport, the designated region may be a boarding gate region, the boarding gate region may be one region type in the airport (i.e., the region type of the location where any boarding gate in the airport is located is a boarding gate region). Generally, the average staying time of passengers at a boarding gate of an airport is about 50 minutes. The presentation start point may be determined such that when a public mobile device reaches a designated region, the public mobile device reports a message to a server. If the server receives a message reported by a first public mobile device within a set time range, the server may determine the current system time as the start point for information resource presentation, and issue the determined presentation start point to the public mobile device, which reports a current location, with other public mobile devices also reporting locations within the set time range. The set time range may be set in any suitable manner. For instance, the set time range may be done according to the flight times of two adjacent flights within one day at a certain boarding gate in an airport. For example, the flight times of two adjacent flights at boarding gate A11 may be 10:00 am and 11:00 am respectively, and the set time range may be from 10:00 am to 11:00 am that day.

It is assumed that the predetermined duration is represented as T, and the predetermined duration T is divided into m continuous time intervals, such that:

$$T = {\sum }_{r = 1}^{m} {t}_{r}$$

The length of each time interval may be the same or different than one another.

In step S503, for each time interval, a plurality of information contents may be selected from the i-th type of information content group to form at least one information content group corresponding to the i-th type, with the total duration of all information contents in each information content group being a preset unit duration. Moreover, i may be sequentially taken from 1 to N such that the total duration of an information content sequence generated after permutation and combination of all information content groups corresponding to N types as a group according to the respective playing frequencies requirement.

Continuing this example, the predetermined unit duration may be 1 minute, which corresponds to the time unit in the playing frequency. Thus, when the time unit of the playing frequency changes, corresponding adjustments may also be performed as needed. For example, if the playing frequency is once every few hours, (i.e., the time unit in the playing frequency is 1 hour), then the predetermined unit duration may be 1 hour. The information content selected from various types of information content groups may be grouped by the predetermined unit duration. The total duration of each group of information contents may be the predetermined unit duration (such as 1 minute). The number of information contents in each group may be equal to one another or may be unequal. Generally, for information contents such as airport advertisements, the playing duration of each airport advertisement is usually an integral multiple of 5 seconds, and will not exceed 1 minute (e.g., 10 seconds, 15 seconds, 20 seconds, etc.) Taking one time interval tᵣ as an example, a plurality of information contents may be successively picked from N types of information content groups to form at least one information content group corresponding to each type. A set ‘B’ of new information content groups is thus formed: B={B₁, . . . , Bₘ₁, Bₘ₁₊₁, . . . , Bₘ₂, . . . , B_{N-mN+1}, . . . , B_{N}}.

The duration of each information content group in B is a preset unit duration. Each information content group may include one or more information contents. Information content group: B₁₁, . . . , B₁ₘ₁ includes m1 information content groups selected from G₁ cluster.

Information content group Bₘ₁₊₁, . . . , Bₘ₂ includes m2 information content groups selected from G₂ cluster. Information content group B_{N-mN+1}, . . . , B_{N} includes mN information content groups selected from G_{N} cluster.

Assuming that an information content sequence generated after permutation and combination within any time interval tᵣ is Sᵣ, Sᵣ can be generated according to the following rules:

1) information content group B₁ in set B is added to Sᵣ, the location information of B₁ in Sᵣ is recorded, and a reference location p is set as p=1.

2) each time a next element Bₚ₊₁ is added to circulation sequence Sᵣ, whether the distance from the locations of w elements that already have location information in Sᵣ at this moment to the current blank location in Sᵣ is equal to the reciprocal of the playing frequency of each element B_{w} in w element is sequentially determined.

If equal, then element B_{w} is added to circulation sequence Sᵣ, and the location information of this element in Sᵣ is updated. If unequal, then Bₚ₊₁ is added to the circulation sequence, the location information thereof in Sᵣ is recorded, and the reference location p is updated as p=p+1.

Then, step 2) is repeated until the total duration of the information content groups in Sᵣ is equal to time tᵣ.

It should be noted that the embodiments described herein may employ a plurality of methods to perform permutations and combinations to generate an information content sequence within any suitable time interval.

In step S504, the information content sequence may be generated within each time interval is then used as an information resource to be presented.

The information contents in an information content group, which has been presented in a time interval, may also be presented in other time intervals.

By means of the above technical solution, a plurality of appropriate playing frequencies are set according to the number of times information content is issued from an information resource provider, and an upper limit value and a lower limit value of the playing frequency of an information content preferred by a user, thereby avoiding setting too many playing frequencies when the information resource is issued too frequently by the provider, and reducing the data processing capacity for generating an information content sequence. By means of grouping an information content by the set playing frequency, the presentation of the information resources is dispersed, thus further improving the viewing experience of users. Furthermore, setting a presentation start point and a presentation duration avoids meaningless playing when there are few audiences, saving resources. Dividing the presentation duration into segments takes into account the situation where the current user of the public mobile device may leave early, and ensures that effective information resources can be presented within each divided small time period as much as possible. In addition, dividing the presentation time into segments further reduces data processing capacity, thereby reducing the possibility of crashes caused by heavy loads associated with large data processing capacity, thus ensuring effective generation of information content sequences, and accelerating the generation speed of information content sequences, which is easy and simple to implement.

Hereinafter, the particular implementation will be described in detail by taking two playing frequencies and three playing frequencies as examples.

1. Three Playing Frequencies:

Assume that a public mobile device has already acquired 50 information contents A={A₁, A₂, . . . A₅₀}, the playing time of each information content is 10 s, and these 50 information contents have three playing frequencies, which are respectively: once/2 min, once/6 min and once/12 min. The information contents are then grouped according to three playing frequencies to form three clusters corresponding to the three playing frequencies. At least one information content group is selected from the three clusters, respectively. The duration of each information content group is equal to 1 minute, thus forming an information content group set: C={C₁, C₂, . . . , C₉}, C₁=(A₁, A₂, A₃, A₄, A₅, A₆), C₂=(A₇, A₈, A₉, A₁₀, A₁₁, A₁₂) . . . C₉=(A₄₉, A₅₀).

It is assumed that C₁ is selected from a cluster with a playing frequency of once/2 min, C₂, C₃, C₆ and C₇ are selected from a cluster with a playing frequency of once/6 min, and C₄, C₅, C₈ and C₉ are selected from a cluster with a playing frequency of once/12 min. It is further assumed that the playing time is 48 minutes, and that the playing time is divided into two segments of 24 minutes, then:

Within the First 24 Minutes:

At least one information content group is selected from three clusters corresponding to three frequencies respectively to generate an information content group set B={B1, B2, B₃, B₄, B₅}. B₁ corresponds to C₁, B₂ and B₃ correspond to C₂ and C₃ respectively, and B₄ and B₅ correspond to C₄ and C₅ respectively. Then, the information content sequence generated according to the method shown in FIG. 5 is: C₁ C₂ C₁ C₃ C₁ C₄ C₁ C₂ C₁ C₃ C₁ C₅/C₁ C₂ C₁ C₃ C₁ C₄ C₁ C₂ C₁ C₃ C₁ C₅.

As such, C₁ is played once every 2 minutes and played 12 times totally within the first time period; C₂ and C₃ are played once every 6 minutes and played 4 times respectively within the first time period; and C₄ and C₅ are played once every 12 minutes and played 2 times respectively within the first time period.

Within the Second 24 Minutes:

At least one information content group is picked from three clusters corresponding to three frequencies respectively to generate an information content group set B={B₁, B₂, B₃, B₄, B₅}. B₁ corresponds to C₁, B₂ and B₃ correspond to C₆ and C₇ respectively, and B4 and B5 correspond to C₈ and C₉ respectively. Then the information content sequence generated after permutation and combination is: C₁ C₆ C₁ C₇ C₁ C₈ C₁ C₆ C₁ C₇ C₁ C₉/C₁ C₆ C₁ C₇ C₁C₈ C₁C₆ C₁C₇ C₁C₉.

As such, C₁ is played once every 2 minutes and played 12 times totally within the second time period; C₂ and C₃ are played once every 6 minutes and played 4 times respectively within the second time period; and C₄ and C₅ are played once every 12 minutes and played 2 times respectively within the second time period. The remaining 40 s in C₉ may play flight information so as to be occupied and may also be stopped.

2. Two Playing Frequencies:

Further assume that a public mobile device has already acquired 50 information contents A={A₁, A₂, . . . A₅₀}, the playing time of each information content is 10 s, and these 50 information contents have two playing frequencies, which are once/2 min and once/4 min, respectively. Then, the information contents may be grouped according to two playing frequencies to form two clusters corresponding to two playing frequencies. At least one information content group is picked from two clusters, respectively. The duration of each information content group is equal to 1 minute, thus forming an information content group set

C={C₁, C₂, . . . , C₉}, C₁=(A₁, A₂, A₃, A₄, A₅, A₆), C₂=(A₇, A₈, A₉, A₁₀, A₁₁, A₁₂) . . . C₉=(A₄₉, A₅₀).

C₁, C₆ and C₇ are selected from a cluster with a playing frequency of once/2 min, and C₂, C₃, C₄, C₅, C₈ and C₉ are selected from a cluster with a playing frequency of once/4 min. It is also assumed that the playing time is 60 minutes, and the playing time is divided into three segments of 20 minutes, then:

Within the First 20 Minutes:

At least one information content group is selected from two clusters corresponding to two frequencies, respectively to generate an information content group set B={B₁, B₂, B₃}. B1 corresponds to C₁, and B₂ and B₃ correspond to C₂ and C₃, respectively. Then, the information content sequence generated according to the method shown in FIG. 5 is: C₁C₂ C₁C₃/C₁C₂ C₁C₃/ . . . /C₁C₂ C₁C₃.

C1 is played once per 2 minutes, and played a total of 10 times, and C₂ and C₃ are played once per 4 minutes and played a total of 5 times.

Within the Second 20 Minutes:

At least one information content group is picked from two clusters corresponding to two frequencies, respectively, to generate an information content group set B={B₁, B₂, B₃}. B1 corresponds to C₁, and B₂ and B₃ correspond to C₄ and C₅, respectively. Then, the information content sequence generated after permutation and combination is: C₁ C₄ C₁ C₅/C₁ C₄ C₁ C₅/ . . . /C₁C₄ C₁C₅.

C₁ is played once per 2 minutes and played a total of 10 times, and C₂ and C₅ are played once per 4 minutes and played a total of 5 times. Of course, within the second 20 minutes, C₁ may also be replaced with C₆ or C₇.

Within the Third 20 Minutes:

At least one information content group is picked from two clusters corresponding to two frequencies, respectively, to generate an information content group set B={B₁, B₂, B₃}. B1 corresponds to C₇, and B₂ and B₃ correspond to C₈ and C₉, respectively. Then, the information content sequence generated after permutation and combination is: C₇C₈ C₇C₅/C₇C₈ C₇C₉/ . . . /C₇C₈ C₇C₉.

C₇ is played once per 2 minutes and played a total of 10 times, and C₈ and C₉ are played once per 4 minutes and played a total of 5 times.

Furthermore, the presentation start points of various public mobile devices may be the same time point. As such, the pictures of each of the public mobile devices in the environment may be synchronized, the user may be exposed repeatedly to displayed information via screen synchronization, hence enhancing his memory of the information, which is more beneficial to promote the information resources.

Preferably, the generated information content sequence includes at least two circulations of information content sub-sequences. As such, each group of information contents in the information content sequence may appear at least twice within one time interval, such that the spacing interval between two impressions by the user to the information resource will not be too long, thereby increasing the impression of the information content to the user, and thus providing a better information resource presentation promotion effect.

Preferably, the information content sequences generated within different time intervals are different to ensure that the information contents in all types of information content groups are presented within the presentation time period. As such, information contents with different playing frequencies may all be presented within the preset duration.

It should be noted that within any one time interval period, when the total duration of the remaining information contents in a group after grouping by frequency cannot be exactly divided by the preset unit duration, other types of information may be presented to fill the blank time. For instance, using a trolley in an airport playing an advertisement at a boarding gate region as an example, when the total duration of the remaining advertisements in a group of one frequency merely has 45 seconds, flight information may be presented within 15 seconds to satisfy the duration requirement of 1 minute.

A non-volatile computer storage medium storing computer-executable instructions is provided according to an embodiment. The computer-executable instructions may implement the control method for information resource presentation of a public mobile device for any of the embodiments described herein, such as the various method embodiments mentioned above, for example.

As an implementation, the non-volatile computer storage medium in the present disclosure stores a computer-executable program for implementing the following operations: a public mobile device determining the region type of the location where it is located during movement; the public mobile device determining an information resource presentation rule matching the region type according to the determined region type, with different region types corresponding to different information resource presentation rules; and the public mobile device presenting an acquired information resource according to the determined information resource presentation rule.

The non-volatile computer readable storage medium may be used to store a non-volatile software program, a non-volatile computer-executable program and module, such as the program instructions/modules corresponding to the control method for information resource presentation of a public mobile device in the embodiments of the present disclosure, for example. The one or more modules may be stored in the non-volatile computer readable storage medium, and when executed by the processor, perform any of the embodiments described herein, such as the various method embodiments mentioned above, for example.

The non-volatile computer readable storage medium may include a program storage area and a data storage area. The program storage area may store an operating system and an application that performed one or more functions. The data storage area may store data and so on created according to the information resource presentation method. In addition, the non-volatile computer readable storage medium may include a high speed random access memory, and may also include a non-volatile memory, such as at least one magnetic disk storage device, a flash memory device, or other non-volatile solid-state storage devices. In some embodiments, the non-volatile computer readable storage medium may alternatively include a memory that is remote from the processor, which may be coupled to a control system for information resource presentation via a network. The examples of the above network may include, but are not limited to, for example, the Internet, an intranet, a local area network, a mobile communication network, etc., or any combinations thereof.

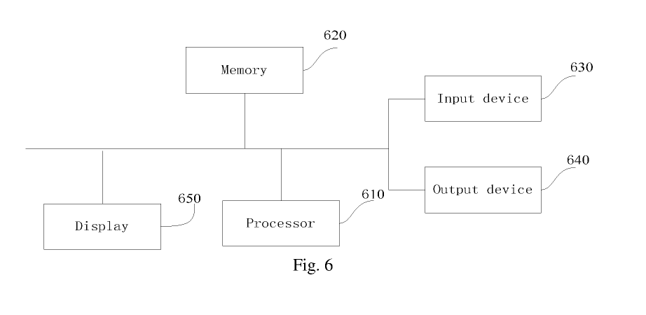

FIG. 6 is a structure diagram of a public mobile device provided according to an embodiment. The public mobile device may be deployed in different regions. As shown in FIG. 6, the public mobile device may include: one or more processors 610, a memory 620, and at least one display 650. Although FIG. 6 shows the public mobile device as having a single processor 610, embodiments include the public mobile device implementing any suitable number and/or type of processors to execute the embodiments as described herein.

In an embodiment, the display 650 may be implemented as a public electronic display screen having a projection angle facing an external public view space, which is provided at the front end of the public mobile device and away from the direction of the user. In other words, facing the public area and having a slight overlook viewing angle, such that the effects are better when being viewed in the front. The public electronic display screen may be any suitable size, such as between 15 inches and 40 inches, for example, and preferably 27 inches.

As such, people walking in front of the public mobile device may also see the contents displayed on the electronic display screen clearly, and thus more people may see the contents displayed on the electronic display screen.

In an alternative embodiment, the display 650 may also be implemented as an interactive display screen having a projection angle that faces the public mobile device, and can be touched by a user to facilitate various public services. The interactive display screen and the public electronic display screen facing may display information resources synchronously.

In embodiments, the device for performing the information resource presentation method for a public mobile device may also include an input device 630 and an output device 640.

The processor 610, the memory 620, the input device 630, and the output device 640 may be interconnected via a bus or any other suitable connection. FIG. 6 is illustrated showing a bus connection as an example, although the interconnections may be implemented as any suitable number and/or type of wired and/or wireless connections.

The memory 620 may be implemented, for instance, as the above-mentioned non-transient computer readable storage medium. The processor 610 may thus perform the functional applications and data processing of the server by executing the non-volatile software program, instructions, and modules stored in the memory 620 (i.e., implementing the control method for information resource presentation of a public mobile device as described in the above method embodiments).

The output device 630 may receive digit or character information and generate key signal input related to the user configuration, and function to control a multi-platform service system of the memory 620.

The above public mobile device may perform the methods provided in the embodiments of the present invention and have corresponding functional modules and beneficial effects corresponding to the implementation of such methods. The technical details, which are not described in detail for purposes of brevity, may be executed to perform the methods described in the various embodiments of the present disclosure.

As an embodiment, the above public mobile device may include: at least one processor, at least one display, and a memory communicatively coupled to the at least one processor. The memory may store instructions executable by the at least one processor to perform the following operations: the public mobile device determining a region type of the location where it is located during movement; the public mobile device determining an information resource presentation rule matching the region type according to the determined region type, with different region types corresponding to different information resource presentation rules; and the public mobile device presenting an acquired information resource according to the determined information resource presentation rule.

### Technical Advantages

The embodiments described herein may be implemented as part of one or more computer components, such as public mobile devices and/or one or more server components. As such, the embodiments described herein may be implemented as part of a computer network architecture that facilitates communications between various other devices and/or components. Thus, the embodiments described herein address and solve issues of a technical nature that are necessarily rooted in computer technology.

In doing so, the embodiments also address issues related to processing and resource usage by servers and/or public mobile devices. For example, by utilizing different rules to present information according to different location types, additional flexibility is provided. Without the advantages provided by the embodiments described herein, this flexibility could not be possible. Furthermore, this flexibility provides additional technical advantages in that processing resources are streamlined and the overall operation of information delivery can be performed in a more efficient manner. In other words, without the advantages of the embodiments described herein, the same content would be delivered to device despite their location, and in doing so processing resources would be wasted by delivering unnecessary or irrelevant information to a large number of users. As a result, the server that determines how information is delivered may conserve processing resources and memory via a more efficient information delivery means that is realized by the embodiments. And as discussed herein, information resource presentation rules may be designated according to priorities, allowing for the control of information presentation, which also avoids resource waste. Therefore, the embodiments described herein also help address issues related to controlling processing resources and regulating power usage.

The device embodiments described above are merely illustrative. Units described herein as being separate components may be or may not be separated physically. Components described as units may be or may not be physical units. For instance, various components or units described herein may be located at the same place, or may be distributed over a communication network or as several networked units. The solution achieved by each of the embodiments may thus be realized by selecting some or all modules, components, units, etc., according to actual needs.

By means of the description of the above implementations, those skilled in the art may clearly understand that various implementations may be realized by means of software plus any suitable hardware platform, and may also be realized by means of hardware. Based on such understanding, the essence of the above technical solution may be embodied as a software product stored in a computer-readable medium such as ROM/RAM, magnetic diskette, optical disc, etc., and comprising instructions for execution by a computer device (such as a personal computer, a server, or a network device) to implement the various methods in accordance with the various embodiments described herein, or parts thereof.

Finally, it should be noted that the above embodiments are merely provided for describing the technical solution of the present disclosure, but are not intended as a limitation. Although the present disclosure has been described in detail with reference to the embodiments, those skilled in the art will appreciate that the technical solution described in the various embodiments above can still be modified, or some technical features therein can be equivalently replaced. Such modifications or replacements do not make the essence of corresponding technical solutions depart from the spirit and scope of technical solutions embodiments of the present disclosure.

What is claimed is:

1. A control method for information presentation of a public mobile device, comprising:
determining, by the public mobile device during movement, a region type of a location where the public mobile device is currently located;
determining, by the public mobile device, an information presentation rule matching the determined region type,
wherein different region types correspond to different information presentation rules; and
presenting, by the public mobile device, acquired information according to the determined information presentation rule.

2. The method according to claim 1, wherein the act of determining the region type comprises:
determining, by the public mobile device, the location of the public mobile device according to a pre-stored complete map of a movement region range and current location coordinates of the public mobile device in the movement region range; and
determining, by the public mobile device, the region type of the location of the public mobile device according to the types of various location regions on the complete map.

3. The method according to claim 1, wherein the act of determining the region type comprises:
when the public mobile device determines that the public mobile device is (i) located nearby a pre-stored known location reference point of a designated region type, (ii) nearby a plurality of other in-use public mobile devices exceeding a preset number, or (iii) nearby a plurality of other in-use public mobile devices exceeding a preset number, and (i) the public mobile device, and (ii) at least some of the plurality of other in-use public mobile devices, are substantially in a static state:
determining, by the public mobile device, that the region type of the location where it is located is a designated region type.

4. The method according to claim 3, wherein the act of determining the region type comprises:
when the public mobile device determines that it does not belong to any designated region type, determining that the region type of the location where the public mobile device is located is a general region type other than the designated region type.

5. The method according to claim 4, wherein the act of determining the information presentation rule comprises:
when the determined region type of the location is a general region type, selecting a general information presentation rule matching the general region type,
wherein the general information presentation rule depends on a number of times an information content is issued; and
when the determined region type of the location is a designated region type, selecting a designated information presentation rule matching the designated region type,
wherein the designated information presentation rule depends on a number of times that information content is issued and an information preference of a user.

6. The method according to claim 5, wherein the information preference of the user comprises an object of interest to the user.

7. The method according to claim 6, further comprising:
generating the designated information presentation rule by:
determining, according to various objects of interest to the user, various information content sets associated with the various objects in an information content pool including un-presented information content in information provided by an information resource provider;
determining the sequential order of information contents to be issued to generate an information content sequence firstly according to a quantity priority of information contents in the various information content sets, secondly according to interest priorities of the various objects, and finally according to priorities of the issuing sequence numbers of various information content in the information content sets; and
using the generated information content sequence as information to be presented.

8. The method according to claim 7, further comprising:
generating the information content sequence by:
(i) determining various information content sets associated with the various objects in the information content pool;
(ii) determining a number of information contents in the various information content sets;
(iii) selecting at least one information content set with the largest number of information contents;
(iv) selecting an information content set with the highest interest priority from the at least one information content set according to the set interest priorities of the various objects;
(v) selecting information content with the smallest sequence number selected from an information content set with the highest interest priority in the information content pool, and adding the information content with the smallest sequence number to the lead position of a blank region of an information content sequence to be presented; and
circulating (i) to (v) until the blank region is fully filled.

9. The method according to claim 8, wherein:
during the generation of the information content sequence, when a playing control instruction to reduce a playing frequency of at least one information content is received, the at least one information content being removed from the information content sequence to generate a shortened information content sequence,
wherein each playing control instruction contains an intercut period; and
during the playing of the shortened information content sequence, the removed at least one information content is intercut according to a respective intercut period.

10. The method according to claim 6, further comprising:
generating the designated information presentation rule by:
determining, according to various objects of interest to the user, various information content sets associated with the various objects in an information content pool consisting of un-presented information contents in information provided by an information resource provider;
determining the sequential order of information contents to be issued to generate an information content sequence, firstly according to a quantity priority of information contents in the information content sets, secondly according to interest priorities of the various objects, thirdly according to a priority of the number of times various information contents are issued required by the information provided in the information content sets, and finally according to priorities of the issuing sequence numbers of various information contents in the information content sets; and
using the generated information content sequence as information to be presented.

11. The method according to claim 10, further comprising:
generating the information content sequence by:
(i) determining various information content sets associated with the various objects in the information content pool;
(ii) determining a number of information contents in the various information content sets;
(iii) selecting at least one information content set with a largest number of information contents;
(iv) selecting a first information content set with a highest interest priority from the at least one information content set according to the set interest priorities of the various objects;
(v) selecting a second information content set with a largest number of times an information content is played from the first information content set;
(vi) selecting an information content with the smallest sequence number from the second information content set in the information content pool, and adding the information content with the smallest sequence number from the second information content set in the information content pool to the lead position of a blank region of an information content sequence to be presented; and
circulating (i) to (vi) until the blank region is fully filled.

12. The method according to claim 5, wherein the information preference of the user includes an upper limit and a lower limit of a playing frequency of an information content preferred by the user, the method further comprising:
generating the designated information presentation rule by:
setting multiple types of playing frequencies corresponding to various information contents according to a number of times various information contents are issued from various information content providers, and the upper limit and the lower limit of the playing frequency of the information content preferred by the user,
wherein the number of types of the playing frequencies is smaller than the number of issuance times; and
generating an information content sequence to be used as information to be presented according to the preset multiple types of playing frequencies corresponding to the various information content.

13. The method according to claim 12, wherein generating the information content sequence comprises:
grouping multiple information contents in acquired information with reference to a set of playing frequencies corresponding to the various information contents to form N types of information content groups,
wherein each type of information content group corresponds to one playing frequency;
when the public mobile device determines that the region type is a designated region type, determining a presentation start point and dividing a presentation time period starting from the presentation start point into a plurality of time intervals;
for each time interval, selecting a plurality of information contents from the i-th type of information content group to form at least one information content group corresponding to the i-th type,
wherein a total duration of information contents in each information content group is a preset unit duration, and sequentially taking i from 1 to N such that a total duration of an information content sequence generated after permutation and combination of each of the information content groups corresponds to N types as a group and is done according to the respective playing frequencies; and
taking an information content sequence generated within each time interval as information to be presented.

14. The method according to claim 13, wherein the presentation start point is received from a server after the public mobile device reports that the public mobile device has arrived at a designated region, the presentation start point acquired by each public mobile device from the server being the same time point.

15. The method according to claim 13, wherein the information content sequences generated within different time intervals are different such that the information contents in the types of information content groups are presented within the presentation time period, and wherein the information content sequence includes at least two circulations of the same information content sub-sequence.

16. The method according to claim 13, wherein the set of playing frequencies includes at least two playing frequencies, and
wherein the higher playing frequency between the two playing frequencies is an integral multiple of the lower playing frequency.

17. A public mobile device, comprising:
at least one processor;
a wireless communication device capable of communicating with a server;
at least one display; and
a memory,
wherein the memory stores a program executable by the at least one processor, and the program is executed by the at least one processor to cause the at least one processor to:
determine, during movement of the public mobile device, a region type of a location where the public mobile device is currently located;
determine an information presentation rule matching the determined region type,
wherein different region types correspond to different information presentation rules; and
present acquired information according to the determined information presentation rule.

18. The public mobile device according to claim 17, wherein the at least one processor is further configured to, when executing the program stored in the memory, to determine the region type by:
when the public mobile device determines that the public mobile device is (i) located nearby a pre-stored known location reference point of a designated region type, (ii) nearby a plurality of other in-use public mobile devices exceeding a preset number, or (iii) nearby a plurality of other in-use public mobile devices exceeding a preset number, and (i) the public mobile device, and (ii) at least one of the plurality of other in-use public mobile devices, are substantially in a static state:
determine that the region type of the location where the public mobile device is located is a designated region type.

19. The public mobile device according to claim 18, wherein the at least one processor is further configured to, when executing the program stored in the memory, to determine the region type by:
when the public mobile device determines that it does not belong to any designated region type, to determine that the region type of the location where the public mobile device is located is a general region type other than the designated region type.

20. The public mobile device according to claim 19, wherein the at least one processor is further configured to, when executing the program stored in the memory, to determine the information presentation rule by:
when the determined region type of the location is a general region type, selecting a general information presentation rule matching the general region type,
wherein the general information presentation rule depends on a number of times that information content is issued; and
when the determined region type of the location is a designated region type, selecting a designated information presentation rule matching the designated region type,
wherein the designated information presentation rule depends on a number of times that information content is issued and an information preference of a user.
